(19) United States
(12) Patent Application Publication
(10) Pub. No.: US 2025/0125085 A1
(43) Pub. Date: Apr. 17, 2025

(54) COIL COMPONENT

(71) Applicant: SAMSUNG ELECTRO-MECHANICS CO., LTD., Suwon-si (KR)

(72) Inventors: Sang Jin Kim, Suwon-si (KR); Boum Seock Kim, Suwon-si (KR); Byeong Cheol Moon, Suwon-si (KR); Ju Hwan Yang, Suwon-si (KR); Han Lee, Suwon-si (KR)

(73) Assignee: SAMSUNG ELECTRO-MECHANICS CO., LTD., Suwon-si (KR)

(21) Appl. No.: 18/826,958

(22) Filed: Sep. 6, 2024

(30) Foreign Application Priority Data
Oct. 11, 2023 (KR) 10-2023-0135243

(51) Int. Cl. H01F 27/30; H01F 27/28; H01F 27/29

(52) U.S. Cl. CPC H01F 27/306; H01F 27/2804; H01F 27/292; H01F 2027/2809

(57) ABSTRACT

A coil component includes a body, a first coil including a first coil portion having a winding axis oriented in a first direction and first and second lead-out portions, a second coil including a second coil portion having a winding axis oriented in the first direction and third and fourth lead-out portions, a coupling adjustment portion including a first region located in at least a portion of regions overlapping a first core of the first coil portion and a second core of the second coil portion in the first direction, and a second region located in at least a portion of regions surrounding the first region in a lateral direction and having magnetic permeability, different from magnetic permeability of the first region, first to fourth external electrodes respectively connected to the firth to fourth lead-out portions.

### CROSS-REFERENCE TO RELATED APPLICATION(S)

This application claims the benefit of priority to Korean Patent Application No. 10-2023-0135243 filed on Oct. 11, 2023 in the Korean Intellectual Property Office, the disclosure of which is incorporated herein by reference in its entirety.

### TECHNICAL FIELD

The present disclosure relates to a coil component.

### BACKGROUND

With miniaturization and thinning of electronic devices such as digital TVs, mobile phones, laptops, etc., miniaturization and thinning of coil components applied to the electronic devices are also required, and to meet the requirements, research and development of various wound type or thin film type coil components are actively underway.

Main issues with the miniaturization and thinning of coil components are to achieve conventional equivalent characteristics despite such miniaturization and thinning. In order to meet these requirements, a ratio of a magnetic material in a core filled with the magnetic material should be increased, but there may be a limit to increasing the ratio due to changes in frequency characteristics or the like, depending on strength and insulation of a body of an inductor.

Meanwhile, there is growing demand for an array-type coil component having an advantage of reducing a mounting area of the coil component. The array-type coil component may have a non-coupled inductor, a coupled inductor, or a mixed inductor thereof, depending on a coupling coefficient or mutual inductance between a plurality of coils. In such an array-type inductor, it is necessary to secure characteristics such as saturation current (Iₛₐₜ) or the like while implementing a target coupling coefficient.

### SUMMARY

An aspect of the present disclosure is to provide a coil component suitable for effectively implementing a target coupling coefficient and improving characteristics such as saturation current (Iₛₐₜ) or the like.

According to an aspect of the present disclosure, a coil component includes a body; a first coil disposed in the body, and including a first coil portion having a winding axis oriented in a first direction, and first and second lead-out portions; a second coil disposed in the body, spaced apart from the first coil portion oriented in the first direction, and including a second coil portion having a winding axis oriented in the first direction, and third and fourth lead-out portions; a coupling adjustment portion disposed between the first coil and the second coil to support the first and second coils, and including a first region located in at least a portion of regions overlapping a first core of the first coil portion and a second core of the second coil portion in the first direction, and a second region located in at least a portion of regions surrounding the first region in a lateral direction and having magnetic permeability different from magnetic permeability of the first region; first and second external electrodes respectively connected to the first and second lead-out portions; and third and fourth external electrodes respectively connected to the third and fourth lead-out portions.

In an embodiment, the first and second coil portions may be respectively disposed on first and second surfaces of the coupling adjustment portion, opposite to each other, in the second region.

In an embodiment, the second region may extend onto a side surface of the body.

In an embodiment, the second region may be disposed outside of the first and second coil portions.

In an embodiment, the second region may be surrounded by the body in the lateral direction.

In an embodiment, the first region may extend into a region in which the first and second coil portions overlap in the first direction.

In an embodiment, the second region may extend in a direction in which the first core of the first coil portion and the second core of the second coil portion are located.

In an embodiment, the first region may be integrated with the body.

In an embodiment, the magnetic permeability of the second region may be lower than the magnetic permeability of the first region.

In an embodiment, a packing fraction of magnetic particles of the first region may be higher than a packing fraction of magnetic particles of the second region.

In an embodiment, the first region may include two or more types of magnetic particles having different sizes of D50.

In an embodiment, the second region may include a magnetic sheet.

In an embodiment, the magnetic sheet may include ferrite.

In an embodiment, the first lead-out portion may be disposed on the same level as the first coil portion, and the second lead-out portion may be disposed on the same level as the second coil portion, and the third lead-out portion may be disposed on the same level as the second coil portion and the fourth lead-out portion may be disposed on the same level as the first coil portion.

In an embodiment, the first coil portion may include a plurality of coil layers, and the first and second lead-out portions may be disposed on a side of the first coil portion with respect to the coupling adjustment portion, and the second coil portion may include a plurality of coil layers, and the third and fourth lead-out portions may be disposed on a side of the second coil portion side with respect to the coupling adjustment portion.

In an embodiment, an absolute value of a coupling coefficient of the first and second coils may be in a range from 0.495 to 0.605.

According to an aspect of the present disclosure, a coil component includes a body; a first coil disposed in the body, and including a first coil portion having a winding axis oriented in a first direction, and first and second lead-out portions; a second coil disposed in the body, spaced apart from the first coil portion oriented in the first direction, and including a second coil portion having a winding axis oriented in the first direction, and third and fourth lead-out portions; a coupling adjustment portion disposed between the first coil and the second coil, and including a first region located in at least a portion of regions overlapping a first core of the first coil portion and a second core of the second coil portion in the first direction, and a second region located in at least a portion of regions surrounding the first region in a lateral direction; first and second external electrodes respectively connected to the first and second lead-out portions; and third and fourth external electrodes respectively connected to the third and fourth lead-out portions, wherein the coupling adjustment portion includes an Fe-based alloy, and wherein a composition of the Fe-based alloy included in the first region is different from a composition of the Fe-based alloy included in the second region.

In an embodiment, an Fe amount of the Fe-based alloy included in the first region may be higher than an Fe amount of the Fe-based alloy included in the second region.

In an embodiment, the Fe-based alloy may be an Fe—Si-based alloy, and an Si amount of the Fe—Si-based alloy included in the first region may be higher than an Si amount of the Fe—Si-based alloy included in the second region.

In an embodiment, the Si amount in the Fe—Si-based alloy included in the first region may be 6.5 wt % or more, and the Si amount in the Fe—Si-based alloy included in the second region may be less than 6.5 wt %.

In an embodiment, the Si amount of the Fe—Si-based alloy included in the second region may be in a range from 1 wt % to 5 wt %.

According to an aspect of the present disclosure, a coil component includes a body; a first coil disposed in the body, and including a plurality of first coil layers having a winding axis oriented in a first direction, and first and second lead-out portions; a second coil disposed in the body, and including a plurality of second coil layers having a winding axis oriented in the first direction, and third and fourth lead-out portions; a coupling adjustment portion disposed between the plurality of first coil layers and the plurality of second coil layers, and including a first region located in at least a portion of regions overlapping a first core of the first coil portion and a second core of the second coil portion in the first direction, and a second region located in at least a portion of regions surrounding the first region in a lateral direction and having magnetic permeability, different from magnetic permeability of the first region; first and second external electrodes respectively connected to the first and second lead-out portions; and third and fourth external electrodes respectively connected to the third and fourth lead-out portions.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a transparent perspective view schematically illustrating a coil component according to a first embodiment of the present disclosure.

FIG. 2 is a plan view of the coil component of FIG. 1, viewed from above.

FIG. 3 is an exploded perspective view of a coil and a coupling adjustment portion in the coil component of FIG. 1.

FIG. 4 is a cross-sectional view of the coil component of FIG. 1.

FIG. 5 is an enlarged cross-sectional view of a first region of a coupling adjustment portion.

FIG. 6 is an enlarged cross-sectional view of a second region of a coupling adjustment portion.

FIG. 7 is an enlarged cross-sectional view of a first region of a coupling adjustment portion in a modified example.

FIG. 8 is an enlarged cross-sectional view of a first region of a coupling adjustment portion in a modified example.

FIG. 9 is a cross-sectional view of a coil component according to a modified example.

FIG. 10 is a cross-sectional view of a coil component according to a modified example.

FIG. 11 is a cross-sectional view of a coil component according to a modified example.

FIG. 12 is a transparent perspective view schematically illustrating a coil component according to a second embodiment of the present disclosure.

FIG. 13 is an exploded perspective view of first and second coils in the coil component of FIG. 12.

FIG. 14 is a cross-sectional view of the coil component of FIG. 12.

FIG. 15 is a transparent perspective view schematically illustrating a coil component according to a third embodiment of the present disclosure.

FIG. 16 is an exploded perspective view of a coil and a coupling adjustment portion in the coil component of FIG. 15.

### DETAILED DESCRIPTION

Hereinafter, embodiments of the present disclosure will be described with reference to specific embodiments and the accompanying drawings. However, an embodiment of the present disclosure may be modified to have various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

Various types of electronic components may be used in electronic devices, and various types of coil components may be appropriately used among these electronic components for purposes such as noise removal. In other words, coil components in electronic devices may be used as power inductors, HF inductors, general beads, GHz beads, common mode filters, or the like.

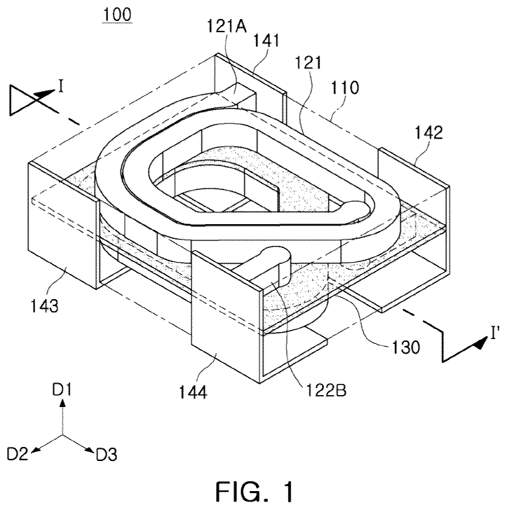

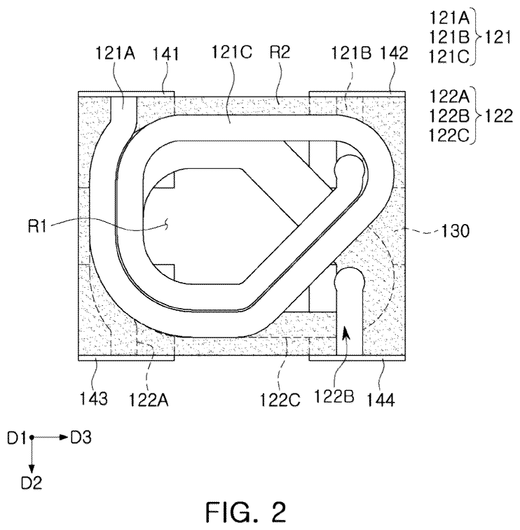

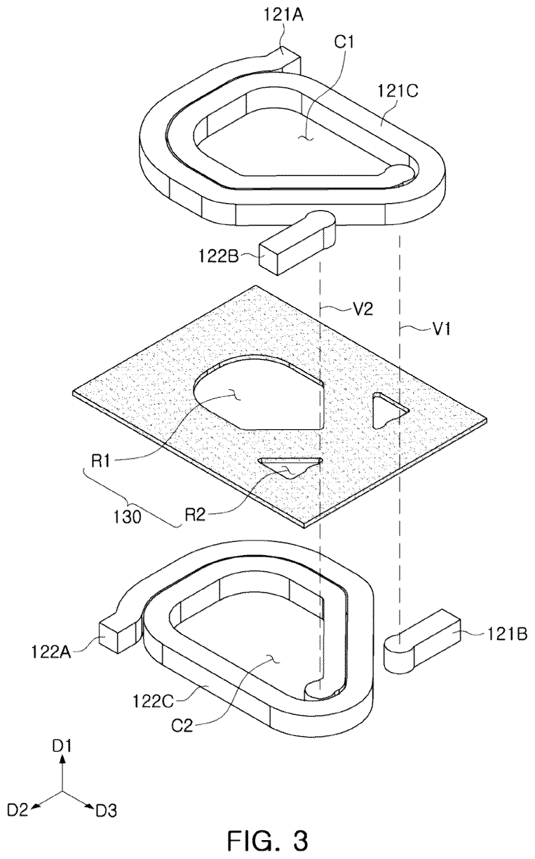

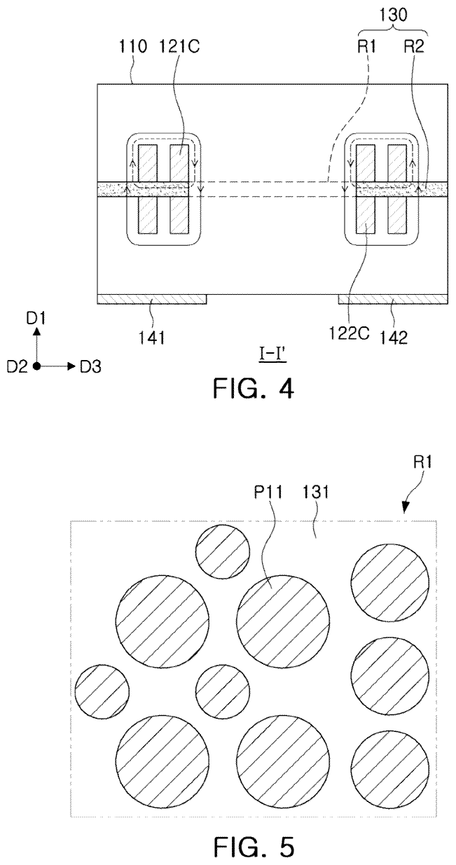

FIG. 1 is a transparent perspective view schematically illustrating a coil component according to a first embodiment of the present disclosure. FIG. 2 is a plan view of the coil component of FIG. 1, viewed from above, and FIG. 3 is an exploded perspective view of a coil and a coupling adjustment portion in the coil component of FIG. 1. FIG. 4 is a cross-sectional view of the coil component of FIG. 1.

Referring to FIGS. 1 to 4, a coil component 100 according to the present embodiment may include a body 110, a first coil 121, a second coil 122, a coupling adjustment portion 130, and first, second, third and fourth external electrodes 141, 142, 143 and 144 respectively, and may be implemented as an array-type inductor in which the first and second coils 121 and 122 are magnetically coupled. In this case, the coupling adjustment portion 130 may include a first region R1 and a second region R2 surrounding the same in a lateral direction, and the first and second regions R1 and R2 may be implemented to have different magnetic permeability, a degree of coupling of the first and second coils 121 and 122 may be appropriately adjusted. Details thereof will be described later, and hereinafter, main elements constituting the coil component 100 of the present embodiment will be described.

The body 110 may have the first and second coils 121 and 122 or the like disposed therein, and may form an overall appearance of the coil component 100. In this case, the body 110 may include an upper surface and a lower surface opposing oriented in a first direction D1, and a plurality of side surfaces connecting them. The body 110 may include an insulating resin and a magnetic material. Specifically, the body 110 may be formed by stacking one or more magnetic composite sheets in which a magnetic material is dispersed in an insulating resin. The magnetic material may be ferrite or a metal magnetic powder particle. Examples of the ferrite may include at least one or more spinel type ferrites, such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites. The metal magnetic powder particle may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particle may be at least one or more of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder. The metal magnetic powder particle may be amorphous or crystalline. For example, the metal magnetic powder particle may be a Fe—Si—B—Cr-based amorphous alloy powder particle, but the present disclosure is not limited thereto. The ferrite and the metal magnetic powder particle may have an average diameter of about 0.1 μm to 30 μm, respectively, but are not limited thereto. The body 110 may include two or more types of magnetic materials dispersed in the resin. In this case, the term “different types of magnetic materials” means that magnetic materials dispersed in a resin are distinguishable from each other by at least one of an average diameter, a composition, a crystallinity, or a shape. The insulating resin may include an epoxy, a polyimide, a liquid crystal polymer, or the like, in a single form or in combined form, but the present disclosure is not limited thereto.

As an example of a manufacturing method, the body 110 may be formed using a lamination method. Specifically, a plurality of unit stacks for manufacturing the body 110 may be prepared and stacked on upper and lower portions of the first and second coils 121 and 122. In this case, the unit stacks may be prepared as sheet types by mixing a magnetic particle, such as a metal or the like, and an organic material such as a thermosetting resin, a binder, a solvent, or the like, to form a slurry, applying the slurry to a carrier film by a doctor blade method, to a thickness of several tens of μm, and drying the same. Therefore, the unit stacks may be manufactured in a form in which the magnetic particle is dispersed in the thermosetting resin such as an epoxy resin, polyimide, or the like.

The first coil 121 may be disposed in the body 110 and may include a first coil portion 121C having a winding axis oriented in the first direction D1 and first and second lead-out portions 121A and 121B. In addition, the second coil 122 may be disposed in the body 110, may be spaced apart from the first coil portion 121C, and may include a second coil portion 122C having a winding axis oriented in the first direction D1 and third and fourth lead-out portions 122A and 122B. In the present embodiment, the first and second coil portions 121C and 122C may each have a single-layer structure. In other words, the first lead-out portion 121A of the first coil 121 may be disposed on the same level as the first coil portion 121C, and the second lead-out portion 121B may be disposed on the same level as the second coil portion 122C. In this case, an end portion of the first coil portion 121C and the second lead-out portion 121B may be connected by a conductive via V1. Similarly, the third lead-out portion 122A of the second coil 122 may be disposed on the same level as the second coil portion 122C, and the fourth lead-out portion 122B may be disposed on the same level as the first coil portion 121C. In this case, an end portion of the second coil portion 122C and the fourth lead-out portion 122B may be connected by a conductive via V2.

As illustrated in FIG. 2, the first and second coil portions 121C and 122C may have a shape that may include both a region in which cores C1 and C2 overlap in a winding axis direction and a region in which the cores C1 and C2 do not overlap in the winding axis direction. Specifically, a portion of a first core C1 of the first coil portion 121C may form a shared core region overlapping a second core C2 of the second coil portion 122C oriented in the first direction D1, and at least a portion of different regions may form a non-shared core region that does not overlap the second core C2 of the second coil portion 122C. Likewise, a portion of the second core C2 of the second coil portion 122C may form a non-shared core region that does not overlap the first core C1 of the first coil portion 121C oriented in the first direction D1.

In the first and second coils 121 and 122, a plating pattern may be formed using a plating process used in the art, such as pattern plating, anisotropic plating, isotropic plating, or the like, and may be formed as a multi-layer structure using a plurality of processes among these processes. Examples of materials constituting the first and second coils C1 and C2 may include a conductive material such as copper (Cu), aluminum (Al), silver (Ag), tin (Sn), gold (Au), nickel (Ni), lead (Pb), titanium (Ti), chromium (Cr), or alloys thereof, but the material is not limited thereto.

The first external electrode 141 and the second external electrode 142 may be connected to the first coil 121, and specifically to the first lead-out portion 121A and the second lead-out portion 121B, respectively. The third external electrode 143 and the fourth external electrode 144 may be connected to the second coil 122, and specifically to the third lead-out portion 122A and the fourth lead-out portion 122B, respectively. In this case, the first external electrode 141 and the second external electrode 142 may be disposed on the same side surface of the body 110, and may extend to a lower surface of the body 110, and similarly, the third external electrode 143 and the fourth external electrode 144 may be disposed on the same side surface of the body 110, and may extend to the lower surface of the body 110. The first to fourth external electrodes 141 to 144 may be formed using a paste including a metal having excellent electrical conductivity, and the paste may be, for example, a conductive paste including nickel (Ni), copper (Cu), tin (Sn), or silver (Ag), or alloys thereof. Additionally, a plating layer may be provided to cover each of the first to fourth external electrodes 141 to 144. In this case, the plating layer may include one or more selected from the group consisting of nickel (Ni), copper (Cu), and tin (Sn). For example, a nickel (Ni) layer and a tin (Sn) layer may be formed sequentially.

The coupling adjustment portion 130 may include a first coil portion 121C and a second coil portion 122C, and may include a first region R1 and a second region R2 having different magnetic permeabilities. More specifically, the first region R1 may be located in at least a portion of regions in which the first core C1 of the first coil portion 121C and the second core C2 of the second coil portion 122C overlap in the first direction D1. Therefore, the first and second coil portions 121C and 122C may form a magnetic flux path (solid arrow in FIG. 4) coupled to each other in at least a portion of the first region R1. The second region R2 may be located in at least a portion of regions surrounding the first region R1 in a lateral direction (e.g., a direction substantially perpendicular to the first direction), and has a different magnetic permeability from the first region R1. At least a portion of the second region R2 may be located in a leaked magnetic flux path (dotted arrow in FIG. 4) of each of the first coil portion 121C and the second coil portion 122C. In this manner, the magnetic permeability of the first and second regions R1 and R2 located in the coupled magnetic flux path and the leakage magnetic flux path, respectively, may be changed to effectively control coupling coefficient of the first and second coils 121 and 122. For example, when the coupling coefficient of the first and second coils 121 and 122 is targeted to be 0.495 or more and less than 0.605, based on an absolute value, it may not be easy to adjust the coupling coefficient by precisely controlling a gap between the first and second coils 121 and 122, a magnetic material of the body 110, or the like. Therefore, the coupling adjustment portion 130 may be disposed between the first and second coils 121 and 122 to implement a target coupling coefficient value, without making the gap between the first and second coils 121 and 122 from being too far from each other or too close to each other.

As a specific example, the second region R2 may have lower magnetic permeability than the first region R1. The first region R1 may form an integrated structure with the body 110. The first region R1 may be manufactured separately from the body 110, and may be formed of magnetic particles having different types or sizes. As in the present embodiment, the magnetic permeability of the second region R2 may be set to be relatively low, a magnitude of each leakage magnetic flux may be reduced, even though the first and second coil portions 121C and 122C do not need to be excessively reduced, and an effect of reducing saturation current (Iₛₐₜ) may also be achieved. The first region R1 may have a relatively high magnetic permeability. When the magnetic permeability of the first region R1 is lowered to a level similar to that of the second region R2, a magnitude of the coupled magnetic flux may be reduced. To compensate therefor, it may be necessary to increase the number of turns of the first and second coil portions 121C and 122C or reduce a gap therebetween. As in the present embodiment, the first region R1 may be set to have a relatively high level of magnetic permeability, a magnitude of the coupled magnetic flux may be sufficiently secured, even though the number of turns of the first and second coil portions 121C and 122C is not increased or a gap therebetween is not excessively reduced, and therefrom, a target coupling coefficient may be effectively implemented.

When describing a specific form of the coupling adjustment portion 130, first, as in the present embodiment, the first and second coil portions 121C and 122C may be disposed on first and second surfaces (corresponding to the upper and lower surfaces, respectively, based on the drawings) opposite to each other, in the second region R2 of the coupling adjustment portion 130. In this case, the first and second coils 121 and 122 may be supported by the coupling adjustment portion 130. Additionally, the second region R2 of the coupling adjustment portion 130 may extend onto the side surface of the body 110. Therefore, the second region R2 may be disposed outside of the first and second coil portions 121C and 122C. In this manner, the second region R2, which has a relatively low magnetic permeability in the coupling adjustment portion 130, may be disposed in a region corresponding to a space between the first and second coil portions 121C and 122C, and in a region corresponding to the outside, a magnitude of leakage magnetic flux of the first and second coils 121 and 122 may be effectively reduced.

A region in which the coupling adjustment portion 130 is formed may be changed, depending on a magnitude of a desired coupling coefficient or other characteristics, and this will be explained with reference to modified examples of FIGS. 9 to 11. First, as in the modified example of FIG. 9, a second region R2 of a coupling adjustment portion 130 may be implemented as a configuration surrounded by a body 110 in the lateral direction. In this case, the second region R2 may be limitedly formed in a region in which first and second coil portions 121C and 122C are formed, and may not be formed outside the first and second coil portions 121C and 122C. When the coupling adjustment portion 130 has this arrangement, a magnitude of coupled magnetic flux of first and second coils 121 and 122 outside the first and second coil portions 121C and 122C may increase.

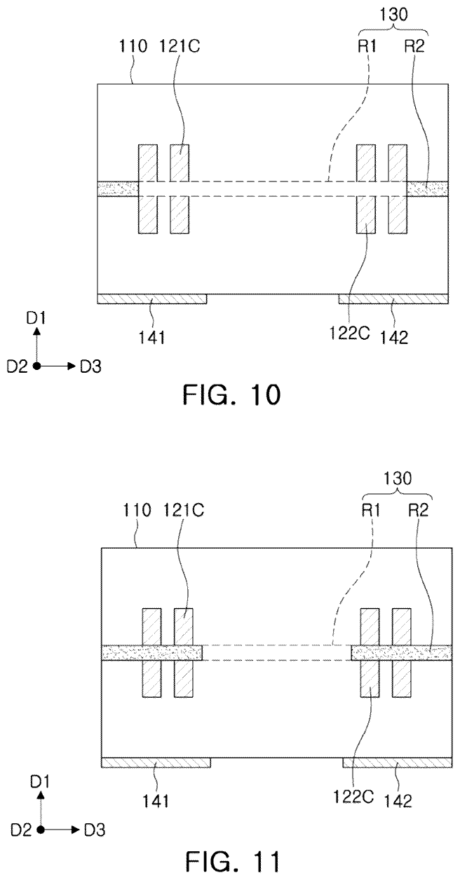

Next, as in the modified example of FIG. 10, a coupling adjustment portion 130 may have a configuration in which a first region R1 is expanded. For example, the first region R1 may be extended into a region in which first and second coil portions 121C and 122C overlap in the first direction D1. In this case, a region in which a second region R2 is formed may be limited to the outside of the first and second coil portions 121C and 122C.

Next, as in the modified example of FIG. 11, a second region R2 of a coupling adjustment portion 130 may be partially expanded in an inward direction. For example, the second region R2 may be implemented as a configuration extending in a direction in which cores of first and second coil portions 121C and 122C are located.

As described above, in the coupling adjustment portion 130, magnetic permeability of the first region R1 may be different from magnetic permeability of the second region R2. For example, the magnetic permeability of the second region R2 may be lower than the magnetic permeability of the first region R1. When it is difficult to measure the magnetic permeability for each region in a state of the coil component 100, a type of magnetic material, a particle size, a packing fraction, etc. included in the first region R1 and the second region R2 may be analyzed to compare magnetic permeability thereof. Hereinafter, a configuration in which magnetic permeability of the first region R1 and magnetic permeability of the second region R2 are adjusted will be described with reference to FIGS. 5 to 8, and a packing fraction of magnetic particles in the second region R2 is adjusted to be lower than a packing fraction of magnetic particles in the first region R1.

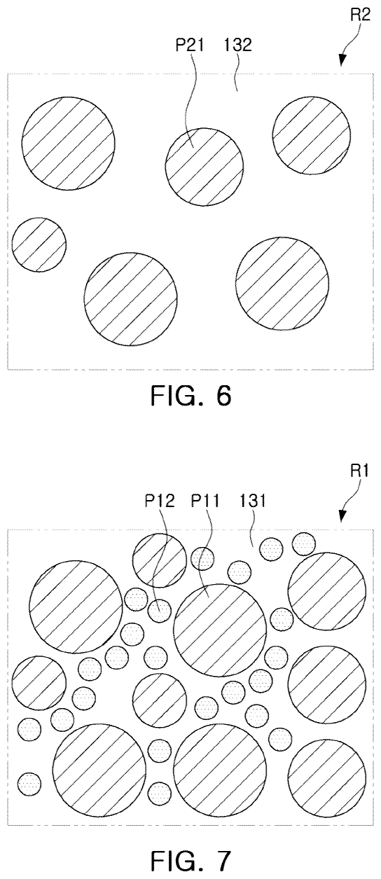

First, referring to FIGS. 5 and 6, a first region R1 may include magnetic particles P11, and an insulating material 131 such as a resin or the like may be interposed between the magnetic particles P11. Likewise, a second region R2 may include magnetic particles P21, and an insulating material 132 such as a resin or the like may be interposed between the magnetic particles P21. As illustrated, a packing fraction of the magnetic particles P11 in the first region R1 may be higher than a packing fraction of the magnetic particles P21 in the second region R2. As an example of a method of obtaining the packing fraction, after obtaining SEM images of the first region R1 and the second region R2, a ratio of an area occupied by the magnetic particles (P11 and P21) relative to a total area may be calculated. In this case, to obtain more accurate values, values for the packing fraction may be obtained from a plurality of cross-sections.

When there may be no significant difference in size of the magnetic particles P11 and P21 in the first region R1 and the second region R2, for example, when a difference between D50 of the magnetic particle P11 in the first region R1 and D50 of the magnetic particles P21 of the second region R2 is 10% or less, the packing fractions of the magnetic particles P11 and P21 may affect magnetic permeability in a region corresponding thereto. In this case, the difference in D50 being 10% or less means that a ratio of difference between large and small values of D50 relative to the large value of D50 is 10% or less. As an example, the magnetic particles P11 included in the first region R1 may have a diameter range of 5 to 61 μm, and similarly, the magnetic particles P21 included in the second region R2 may have a diameter range of 5 to 61 μm.

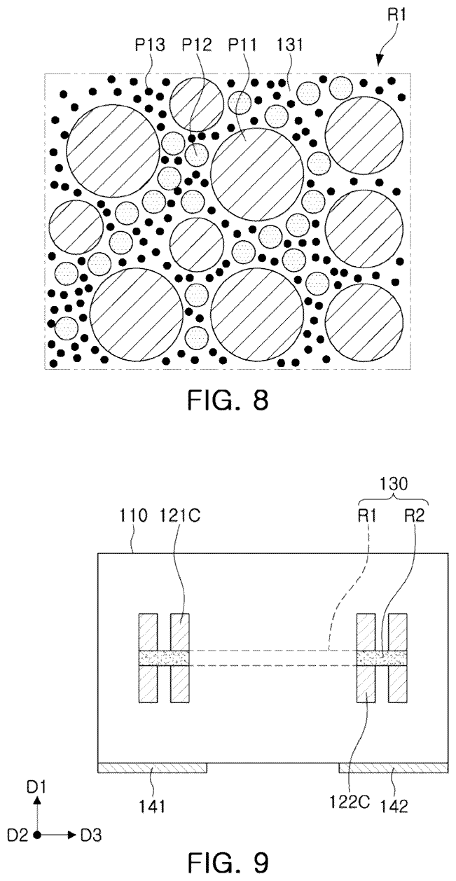

To increase a packing fraction of magnetic particles, magnetic particles having different particle size distributions may be used. For example, the first region R1 may include two or more types of magnetic particles having different sizes of D50. FIG. 7 illustrates an example using two types of particles (P11 and P12), and FIG. 8 illustrates an example using three types of particles (P11, P12, and P13). In this manner, a plurality of magnetic particles with different sizes of D50 may be used to improve a packing fraction of the magnetic particles, and thus magnetic permeability of a region corresponding thereto may increase. In this case, first magnetic particles P11 included in the first region R1 may have a diameter range of 5 to 61 μm, second magnetic particles P12 may have a diameter range of 0.9 to 4.5 μm, and third magnetic particles P13 may have a diameter range of 10 to 800 nm.

Diameters of the magnetic particles (P11 to P13, and P21) present in the coupling adjustment portion 130 may be measured from a cross-section of the coupling adjustment portion 130. Specifically, after photographing a plurality of equally spaced regions (e.g., 5 or 10 regions) in the second direction D2 or the like with respect to a D1-D3 cross-section passing through a center of the body 110 with a scanning electron microscope, the diameters of magnetic particles (P11 to P13, and P21) may be obtained using an analysis program. In this case, as a specific example, an image pixel size in an SEM image may be fixed to 10 nm*10 nm, and a working distance may be fixed to 8 mm. A back scattered mode may be used. Afterwards, an average value of diameters may be calculated using an image analysis program (e.g. a deep learning tool from ORS). The magnetic particles (P11 to P13, and P21) may have a spherical shape or a substantially spherical shape, but are not limited thereto. For example, the magnetic particles (P11 to P13, and P21) may have a non-spherical shape. These shapes may be obtained as sphericity of the magnetic particles (P11 to P13, and P21) decreases during an oxidation process. When the magnetic particles (P11 to P13, and P21) have any shape that does not maintain a spherical shape, the above-mentioned diameter may be interpreted as being replaced with Feret diameter, and an average value of diameters may be also interpreted as being replaced with an average value of Feret diameters. As a method of calculating the average diameter value, a tool in image processing software may be used, and a size distribution may be obtained by particle size analysis for each area. In the above explanation, diameters of the magnetic particles (P11 to P13, and P21) may be measured by taking a plurality of cross-sections from the magnetic component, but when it is difficult to take a plurality of cross-sections, the diameters of the magnetic particles may also be measured on one cross-section, for example, a D1-D3 cross-section, a D1-D2 cross-section, or the like, passing through the center of the body 110.

In the above embodiment, the magnetic permeability of the coupling adjustment portion 130 of the magnetic particles was changed, and for this purpose, a packing rate in each region was adjusted. In contrast, the first and second regions R1 and R2 may have different materials constituting the magnetic particles, and thereby the magnetic permeability may be adjusted. Specifically, the coupling adjustment portion 130 may include an Fe-based alloy, and, in this case, an Fe-based alloy included in the first region R1 and an Fe-based alloy included in the second region R2 may have different compositions. In this case, an Fe amount of the Fe-based alloy included in the first region R1 may be higher than an Fe amount of the Fe-based alloy included in the second region R2, and the Fe amounts may be wt %. Additionally, considering that Si, in addition to Fe, also affects magnetic permeability, an Si amount may also be adjusted together with or independently of Fe. For example, the Fe-based alloy included in the coupling adjustment portion 130 may be an Fe—Si-based alloy, and an Si amount of an Fe—Si-based alloy included in the first region R1 may be higher than an Si amount of an Fe—Si-based alloy included in the second region R2. Specifically, the Si amount in the Fe—Si-based alloy included in the first region R1 may be 6.5 wt % or more, and the Si amount in the Fe—Si-based alloy included in the second region R2 may be less than 6.5 wt %. More specifically, the Si amount in the Fe—Si-based alloy included in the second region R2 may be 1 wt % or more and 5 wt % or less. Additionally, when the Fe-based alloy included in the first region R1 and the Fe-based alloy included in the second region R2 have different compositions, types of elements included therein may be different. For example, elements included in the Fe-based alloy of the first region R1 may not be included in the Fe-based alloy of the second region R2, and vice versa.

Unlike the previous embodiment, it is also possible to implement the second region R2 in the coupling adjustment portion 130, as a sheet, rather than as a magnetic particle. For example, the second region R2 may include a magnetic sheet, and, in this case, the magnetic sheet may include ferrite. In this case, the first region R1 may include magnetic particles formed of an Fe-based alloy that has a relatively higher magnetic permeability than ferrite.

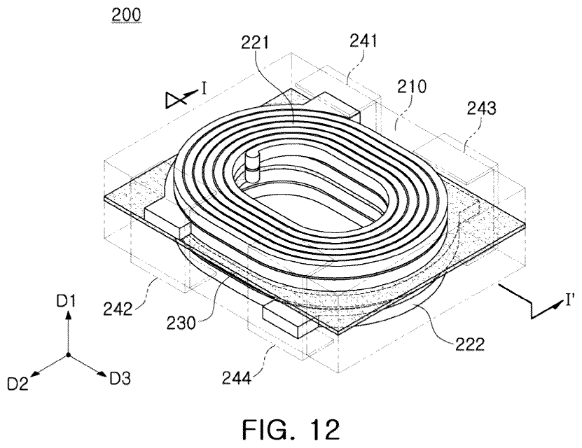

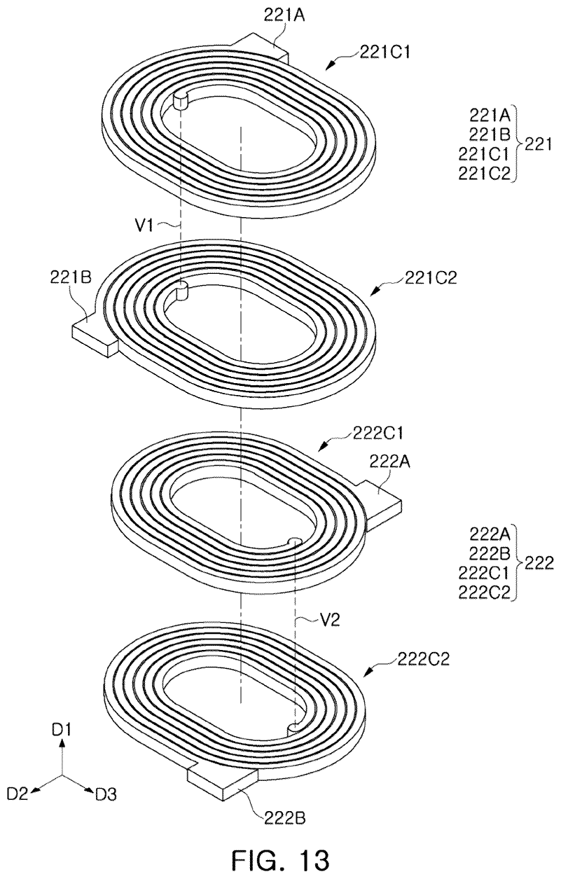

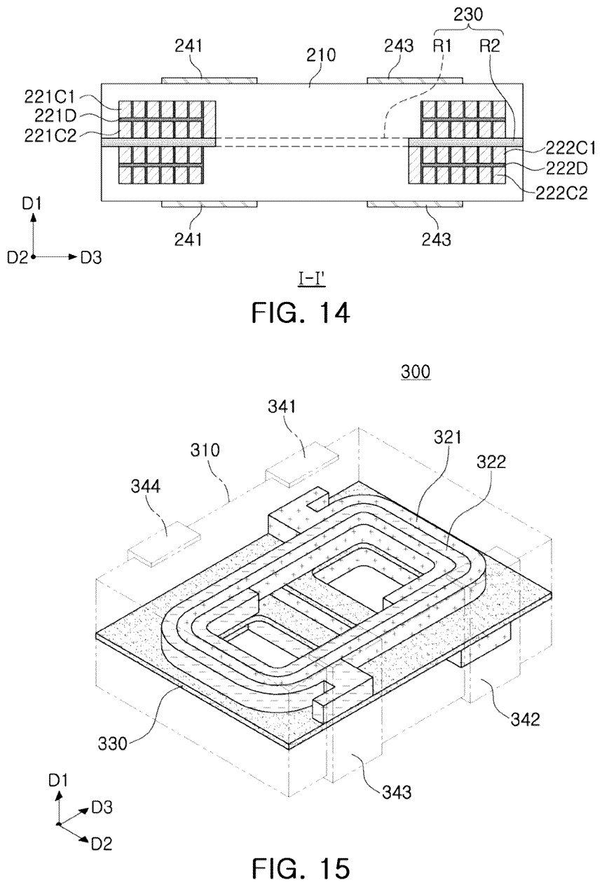

Hereinafter, embodiments in which a specific form of a coil is different from the previous embodiment will be described. Even without specific explanation, all of the preceding embodiments may also be applied to second and third embodiments below. First, in the second embodiment illustrated in FIGS. 12 to 14, a coil component 200 may include a body 210, a first coil 221, a second coil 222, a coupling adjustment portion 230, and first to fourth external electrodes 241 to 244, and may be implemented as an array-type inductor in which the first and second coils 221 and 222 are magnetically coupled. In this case, the coupling adjustment portion 230 may include a first region R1 and a second region R2 surrounding the same in a lateral direction (i.e., a direction substantially perpendicular to the winding axis of the first and second coils), and the first and second regions R1 and R2 may be implemented to have different magnetic permeability, a degree of coupling of the first and second coils 221 and 222 may be appropriately adjusted.

As a structure different from the previous embodiment, in the present embodiment, the first coil 221 and the second coil 222 may have a plurality of coil layers, respectively. Specifically, the first coil portion may include a plurality of coil layers 221C1 and 221C2. An insulating layer 221D may be interposed between the plurality of coil layers 221C1 and 221C2, and the plurality of coil layers 221C1 and 221C2 may be connected to each other by a conductive via V1. First and second lead-out portions 221A and 221B may be disposed on a side of the first coil portion (in an upward direction in the drawings) with respect to the coupling adjustment portion 230. Additionally, the second coil portion may include a plurality of coil layers 222C1 and 222C2. An insulating layer 222D may be interposed between the plurality of coil layers 222C1 and 222C2, and the plurality of coil layers 222C1 and 222C2 may be connected to each other by a conductive via V2. Third and fourth lead-out portions 222A and 222B may be disposed on a side of the second coil portion side (in a downward direction in the drawings) with respect to the coupling adjustment portion 230.

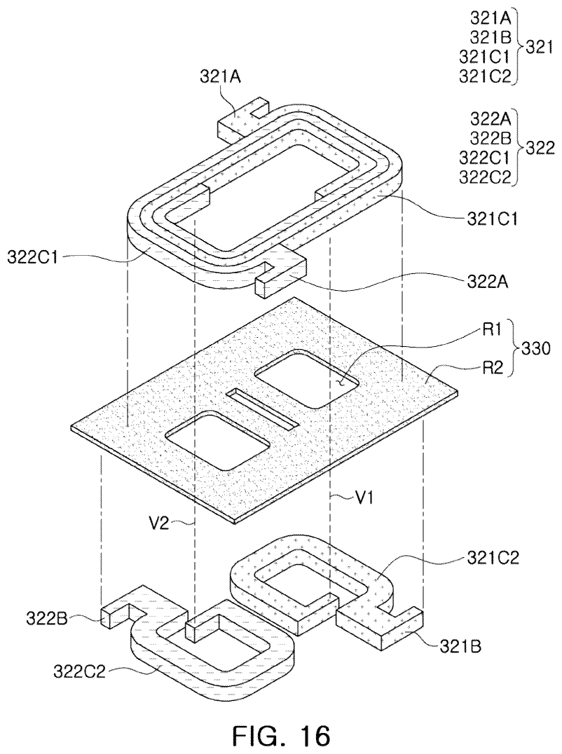

Next, in the third embodiment illustrated in FIGS. 15 and 16, a coil component 300 may include a body 310, a first coil 321, a second coil 322, a coupling adjustment portion 330, and first to fourth external electrodes 341 to 344, and may be implemented as an array-type inductor in which the first and second coils 321 and 322 are magnetically coupled. In this case, the coupling adjustment portion 330 may include a first region R1 and a second region R2 surrounding the same in a lateral direction, and the first and second regions R1 and R2 may be implemented to have different magnetic permeability, a degree of coupling of the first and second coils 321 and 322 may be appropriately adjusted.

As a structure different from the previous embodiment, in the present embodiment, some regions of the first coil 321 and the second coil 322 may have a shape alternately wound around the same winding axis. Specifically, the first coil 321 may include a plurality of first coil layers 321C1 and 321C2 and first and second lead-out portions 321A and 321B, and the second coil 322 may include a plurality of second coil layers 322C1 and 322C2 and first and second lead-out portions 322A and 322B. The coupling adjustment portion 330 may be disposed between the plurality of first coil layers 321C1 and 321C2 and between the plurality of second coil layers 322C1 and 322C2. The first coil layer 321C1 and the second coil layer 322C1 may be disposed on an upper side of the coupling adjustment portion 330, and may have a structure alternately wound with respect to a winding axis in the same direction. The first coil layer 321C2 and the second coil layer 322C2 may be spaced apart on a lower side of the coupling adjustment portion 330, and may be connected to the coil layers 321C1 and 322C1 thereon, respectively, by conductive vias V1 and V2.

A coil component according to an example of the present disclosure may be suitable for effectively implementing a target coupling coefficient and may improve characteristics such as saturation current (Iₛₐₜ) or the like.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
a first coil disposed in the body, and including: a first coil portion having a winding axis oriented in a first direction, and first and second lead-out portions;
a second coil disposed in the body, spaced apart from the first coil portion, and including: a second coil portion having a winding axis oriented in the first direction, and third and fourth lead-out portions;
a coupling adjustment portion disposed between the first coil and the second coil to support the first and second coils, and including: a first region located in at least a portion of regions in which a first core of the first coil portion and a second core of the second coil portion overlap in the first direction, and a second region located in at least a portion of regions surrounding the first region in a lateral direction and having magnetic permeability, different from magnetic permeability of the first region;
first and second external electrodes respectively connected to the first and second lead-out portions; and
third and fourth external electrodes respectively connected to the third and fourth lead-out portions.

2. The coil component of claim 1, wherein the first and second coil portions are respectively disposed on first and second surfaces, opposite to each other, in the second region of the coupling adjustment portion.

3. The coil component of claim 1, wherein the second region extends onto a side surface of the body.

4. The coil component of claim 1, wherein the second region is disposed outside of the first and second coil portions.

5. The coil component of claim 1, wherein the second region is surrounded by the body in the lateral direction.

6. The coil component of claim 1, wherein the first region extends into a region in which the first and second coil portions overlap in the first direction.

7. The coil component of claim 1, wherein the second region extends in a direction in which the first core of the first coil portion and the second core of the second coil portion are located.

8. The coil component of claim 1, wherein the first region is integrated with the body.

9. The coil component of claim 1, wherein the magnetic permeability of the second region is lower than the magnetic permeability of the first region.

10. The coil component of claim 9, wherein a packing fraction of magnetic particles in the first region is higher than a packing fraction of magnetic particles in the second region.

11. The coil component of claim 10, wherein the first region comprises two or more types of magnetic particles having different sizes of D50.

12. The coil component of claim 1, wherein the second region comprises a magnetic sheet.

13. The coil component of claim 12, wherein the magnetic sheet comprises ferrite.

14. The coil component of claim 1, wherein the first lead-out portion is disposed on a same level, in the first direction, as the first coil portion, and the second lead-out portion is disposed on a same level, in the first direction, as the second coil portion, and
the third lead-out portion is disposed on a same level, in the first direction, as the second coil portion and the fourth lead-out portion is disposed on a same level, in the first direction, as the first coil portion.

15. The coil component of claim 1, wherein the first coil portion comprises a plurality of coil layers, and the first and second lead-out portions are disposed on a side of the first coil portion with respect to the coupling adjustment portion, and
the second coil portion comprises a plurality of coil layers, and the third and fourth lead-out portions are disposed on a side of the second coil portion side with respect to the coupling adjustment portion.

16. The coil component of claim 1, wherein an absolute value of a coupling coefficient of the first and second coils is in a range from 0.495 to 0.605.

17. A coil component comprising:
a body;
a first coil disposed in the body, and including: a first coil portion having a winding axis oriented in a first direction, and first and second lead-out portions;
a second coil disposed in the body, spaced apart from the first coil portion, and including: a second coil portion having a winding axis oriented in the first direction, and third and fourth lead-out portions;
a coupling adjustment portion disposed between the first coil and the second coil, and including a first region located in at least a portion of regions in which a first core of the first coil portion and a second core of the second coil portion overlap in the first direction, and a second region located in at least a portion of regions surrounding the first region in a lateral direction;
first and second external electrodes respectively connected to the first and second lead-out portions; and
third and fourth external electrodes respectively connected to the third and fourth lead-out portions,
wherein the coupling adjustment portion includes an Fe-based alloy, and
wherein a composition of the Fe-based alloy included in the first region is different from a composition of the Fe-based alloy included in the second region.

18. The coil component of claim 17, wherein an Fe amount of the Fe-based alloy included in the first region is higher than an Fe amount of the Fe-based alloy included in the second region.

19. The coil component of claim 17, wherein the Fe-based alloy is an Fe—Si-based alloy, and
wherein an Si amount of the Fe—Si-based alloy included in the first region is higher than an Si amount of the Fe—Si-based alloy included in the second region.

20. The coil component of claim 19, wherein the Si amount in the Fe—Si-based alloy included in the first region is 6.5 wt % or more, and the Si amount in the Fe—Si-based alloy included in the second region is less than 6.5 wt %.

21. The coil component of claim 20, wherein the Si amount of the Fe—Si-based alloy included in the second region is in a range from 1 wt % to 5 wt %.

22. A coil component comprising:
a first coil disposed around a first core and having a winding axis oriented in a first direction, the first coil comprising first and second lead-out portions connected respectively to first and second external electrodes;
a second coil disposed around a second core and having a winding axis oriented in the first direction, the second coil comprising third and fourth lead-out portions connected respectively to third and fourth external electrodes;
a coupling adjustment portion disposed between the first coil and the second coil, wherein a first region of the coupling adjustment portion at least partially overlaps the first and second cores and a second region of the coupling adjustment portion surrounds the first region in a direction substantially perpendicular to the first direction,
wherein magnetic permeability of the second region is smaller than magnetic permeability of the first region.

23. The coil component of claim 22, further comprising a body encapsulating the first coil, the second coil and the coupling adjustment portion, wherein the first, second, third and fourth external electrodes are disposed on side surfaces of the body oriented in the first direction.

24. The coil component of claim 22, wherein the coupling adjustment portion comprises a magnetic particles, and wherein a packing fraction of the magnetic particles in the first region is greater than a packing fraction of the magnetic particles in the second region.

25. The coil component of claim 22, wherein the coupling adjustment portion comprises an Fe-based alloy, and wherein an amount of Fe by wt % in the first region is greater than an amount of Fe by wt % in the second region.

26. The coil component of claim 22, wherein the first region extends into a region in which the first and second coil portions overlap in the first direction.
